(19) United States
(12) Patent Application Publication
(10) Pub. No.: US 2007/0002822 A1
(43) Pub. Date: Jan. 4, 2007

(54) Multi homing transport protocol on a multi-processor arrangement

(75) Inventor: Hui Huang, Beijing (CN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/330,189

(22) Filed: Jan. 12, 2006

(30) Foreign Application Priority Data
Jun. 29, 2005 (EP) 05 014 195.1

(51) Int. Cl. H04J 3/24

(52) U.S. Cl. 370/349

(57) ABSTRACT

The invention proposes a processing arrangement (to be used in a communication device, for example), wherein the processing arrangement comprises at least one data processing unit (1), and a communication unit (2) connected to the data processing unit (1), wherein the at least one data processing unit (1) is configured to perform data processing and the communication unit (2) is configured to provide a connection to the external, a packet transport control is used for the connection to the external, in which a plurality of addresses may be assigned to the communication unit (2), and the communication unit and the data processing unit comprise delivering means (13, 23) for delivering packets, which are to be delivered between the data processing unit (1) and the external, via an encapsulated connection (3) between the data processing unit and communication unit. The invention also proposes a corresponding communication method.

### BACKGROUND OF THE INVENTION

1. Field of the Invention

The invention relates to a processing arrangement (to be used, for example, in a communication device) and a method, wherein a communication unit and at least one data processing unit are separately provided and a multi-homing packet transport protocol is used.

2. Description of the Related Art

This invention is related to multi-homing packet transport protocols in connection with multi-processor communication devices. A multi-homing packet transport protocol is a transport protocol which supports multi-homed nodes, i.e., nodes which each can be reached under several addresses. An example for such a transport protocol is SCTP (Stream Control Transport Protocol).

Transport layer multi-homing and mobility have been proposed in new Internet transport protocols, such as the SCTP mentioned above. The feature of multi-homing can be utilized in multi-homed mobile devices (such as a mobile device having simultaneous 2G (second generation), 3G (third generation), WLAN (Wideband Local Area) and Bluetooth accesses), for example), and provides the benefit for redundancy, load balancing and mobility. SCTP has been received much attention due to its attractive features of multi-homing and multi-streaming. It has been proposed to be a transport protocol for multimedia transmission in addition to signalling transmission.

Additionally, in order to increase the processing capability, multi-processor architecture has been used for mobile phones. Normally, one processor handles the communication processing and is called COM engine, and the other processor called APE (Application Processor Environment) engine handles application processing for various applications that may be running on the terminal. Accordingly, two Operation Systems are built on top of the two processors, respectively.

A multi-homed SCTP endpoint can be represented as a list of SCTP transport addresses on the machine that share a single SCTP port. Then, the SCTP endpoint can be denoted by a list of addresses and one port number:

SCTP endpoint=[address 1, address 2, . . . address n: port number]

Therefore, there exist multiple paths between a multi-homed SCTP endpoint and its peer. Normally, the sender transmits data to its primary path, while in the case of failure of the primary path, the sender can switch its transmitting path to an alternative path. SCTP can provide a kind of mobility at the transport layer by adding/deleting an address. To support multi-homing, SCTP has a new system call bindx to bind multiple local addresses to its port, and send its local address list to the remote peer during association establishment.

SCTP is an end-to-end transport protocol, and a multi-homed SCTP endpoint can establish multiple paths to the remote SCTP peer. For this reason, SCTP must provide its address information to its peer in the so-called INIT/INIT-ACK chunks during the association setup phase.

However, although a dual processor mobile phone is a multi-homed machine, the APE on the mobile phone mentioned above does only know its local interface to the COM engine and is not aware of the interfaces to the external network. Thus, the SCTP application(s) running on the APE can not inform its peer about its multiple address information. That is, the multi-homing feature of SCTP can not be realized.

This problem does not only occur in connection with SCTP, but also with other multi-homing packet transport protocols, such as DCCP (Datagram Congestion Control Protocol) or TCP-MH (Transport Control Protocol-Multi-Homing, the TCP protocol being augmented by multi-homing features), for example.

### SUMMARY OF THE INVENTION

Hence, it is an object of the present invention to solve the problem mentioned above and to enable support of transport layer multi-homing for a dual processor arrangement such as a mobile phone.

This object is solved by a processing arrangement, comprising

at least one data processing unit, and

a communication unit connected to the data processing unit, wherein

the at least one data processing unit is configured to perform data processing and the communication unit is configured to provide a connection to the external,

a packet transport control is used for the connection to the external, in which a plurality of addresses may be assigned to the communication unit, and

the communication unit and the data processing unit comprise delivering means for delivering packets, which are to be delivered between the data processing unit and the external, via an encapsulated connection between the data processing unit and communication unit.

Alternatively, the above object is solved by a method for performing communication of a processing arrangement comprising at least one data processing unit, and a communication unit connected to the data processing unit and configured to provide a connection to an external node, wherein

a packet transport control is used for the connection between the communication unit and the external node, in which packet transport protocol a plurality of addresses may be assigned to the communication unit, the method comprising the step of

delivering packets, which are to be delivered between the data processing unit and the external, via an encapsulated connection between the data processing unit and communication unit.

The invention also proposes a communication unit, wherein a packet transport control is used for the connection to the external, in which a plurality of addresses may be assigned to the communication unit, wherein

the communication unit comprise delivering means for delivering packets, which are to be delivered between a data processing unit and the external, via an encapsulated connection between the data processing unit and communication unit.

Moreover, the invention also suggests a data processing unit, wherein

the data processing unit is configured to perform data processing and a packet transport control is used for the connection to the external, in which a plurality of addresses may be assigned to a communication unit connected to the data processing unit, and

the data processing unit comprise delivering means for delivering packets, which are to be delivered between the data processing unit and the external, via an encapsulated connection between the data processing unit and communication unit.

Thus, according to the invention, a encapsulated connection, i.e., a tunnel is established between the data processing unit and the communication unit. In this way, packets can be forwarded transparently to and from the data processing unit to and from an external host. Hence, although the data processing unit only knows the local address of the communication unit, it can use the plurality of addresses assigned to the communication unit.

That is, the data processing unit can use the features of the multi-home packet transport protocol (such as SCTP) normally, wherein the encapsulated connection between the data processing unit and the communication unit is fully transparent to the data processing unit.

Therefore, transport layer multi-homing and mobility can easily be provided for dual-processor communication devices.

Sending to and receiving from “external”, as used in the present application, is to be understood such that packets are sent to or received from external nodes or hosts, i.e., nodes which are separate from the processing arrangement (the communication device).

Further advantageous developments are set out in the dependent claims.

For example, the data processing unit may comprise means for generating packets by using addresses of the communication unit as a source address, wherein the delivering means of the data processing unit is configured to encapsulate said packets by using the address of the communication unit as address of the encapsulated packet. In this case, the delivering means of the communication unit may be configured to decapsulate the encapsulated packets received from the data processing unit and to send the decapsulated packet to the external.

The delivering means of the communication unit may be configured to encapsulate packets received from the external by using the local address of the data processing unit as the address of the encapsulated packet, and the communication unit may be configured to send the encapsulated packets to the data processing unit. Then, the delivering means of the data processing unit may be configured to decapsulate said received packets.

Furthermore, the communication unit may comprise an interface monitoring means for monitoring address changes of the communication unit and for forwarding address information to the data processing unit.

Also, the data processing unit may comprise an address managing means for assigning addresses of the communication unit to the packets, which are to be sent between the data processing unit and the external. Furthermore, the address managing means may be configured to receive the address information sent from the interface monitoring means of the communication unit.

Moreover, the communication unit may comprise a packet type distinguishing means for detecting the type of a packet and for forwarding the packet to an application part of the communication unit depending on the type of the packet. The packet type distinguishing means may be configured to detect the type of a packet based on the port number of the packet.

The transport protocol may be one of the following: Stream Control Transport Protocol (SCTP), Datagram Congestion Control Protocol (DCCP) or Transport Control Protocol—Multi-Homing (TCP-MH).

The processing arrangement may comprise a first and a second processor, wherein the first processor may comprise the data processing unit and the second processor may comprise the communication unit.

The processing arrangement may be included in a communication device, for example.

### BRIEF DESCRIPTION OF THE DRAWINGS

The invention is described by referring to the enclosed drawings, in which:

FIG. 1 shows an external host and a mobile device according to an embodiment of the present invention,

FIG. 2 shows a signalling flow between an APE engine and a COM engine of the mobile device according to the embodiment of the present invention and an external host upon sending a packet from the APE engine to the external host, and

FIG. 3 shows a signalling flow between an external host, the COM engine and the APE engine of the mobile device according to the embodiment of the present invention upon receiving a packet from the APE engine to the external host, and

FIG. 4 shows implementation modules of the COM engine and the APE engine according to the present embodiment.

### DETAILED DESCRIPTION OF THE PREFERRED EMBODIMENT

In the following, a preferred embodiment of the present invention is described by referring to the attached drawings.

In the embodiment described in the following, SCTP (Stream Control Transport Protocol) is used as an example for a multi-homing packet transport protocol. An SCTP protocol data unit consists of a common header including source and destination addresses, verification tag and checksum, and of one or more so-called chunks. A chunk is a unit of information within an SCTP packet, consisting of a chunk header and chunk-specific content. There may be data chunks which include user data, and control chunks, which deliver control data. Examples for such control chunks are INIT chunk and INIT-ACK chunk mentioned earlier.

According to the present embodiment, a tunneling scheme is used in order to provide SCTP multihoming support on dual processor mobile device. In detail, according to the present embodiment, a tunnel as an example for an encapsulating connection is provided between an APE (Application Processor Environment) engine as an example for a data processing unit and a COM (Communication Module) engine (as an example for a communication unit) of a dual processor mobile phone as an example for a communication device comprising such a processing arrangement. By this tunnel connection, the APE engine can use the COM's addresses to communicate with an external SCTP peer, and the corresponding packets are encapsulated such that they are addressed to the COM engine. Here, the encapsulated packets are decapsulated and can be send to the corresponding SCTP peer to which they are addressed.

Upon receiving packets from the external host, the above procedure is performed the other way round, namely, the received packets are tunneled to the APE engine. That is, the received packets are encapsulated by using the local address of the APE engine and sent thereto. In the APE engine, the packets are decapusulated again and forwarded to the corresponding application layer. There, the packets can be processed as if they were directly received from the external host.

In more detail, according to the present embodiment an Interface Monitor (IM) inside the COM engine can be aware of the IP address changes on COM and then informs the APE engine about the IP addresses information of the COM engine via a special COM address management (CAM) module. In addition, an IP in IP tunnel is established between the COM engine and the APE engine, as described above. In this way, the applications on APE can use COM's IP addresses to communicate with the External SCTP peer as the SCTP packets are sent out from the COM engine. The packets sent to the external hosts are encapsulated in the tunnel between APE and the COM engine. When packets arrive at the COM engine from the APE engine, the packet are decapsulated and sent to the external host.

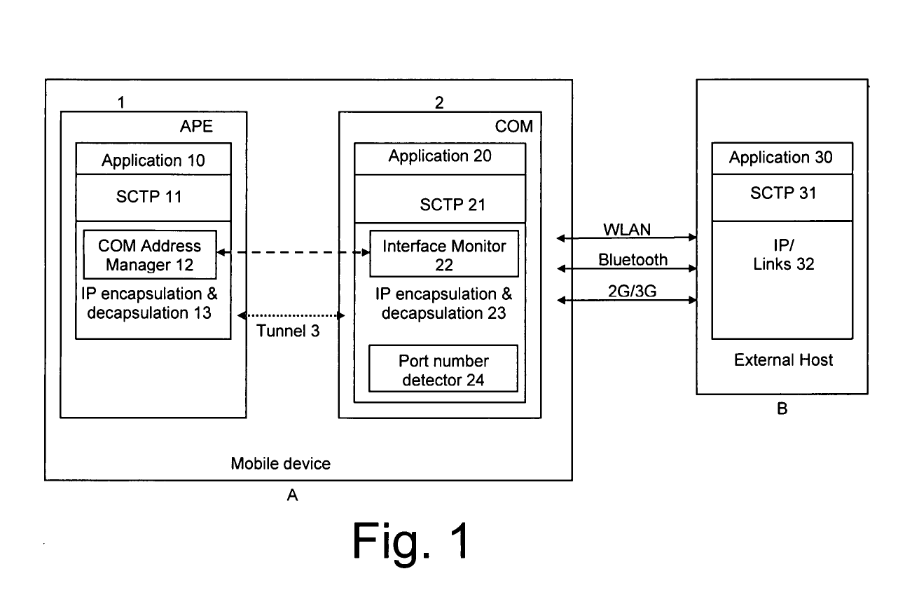

FIG. 1 shows a detailed example of the structure of a mobile device A according to an embodiment of the present invention in connection with an external host B.

In detail, the mobile device A comprises an APE engine 1 and a COM engine 2. Basically, APE handles application processing and COM handles communication to the external hosts (i.e., the communication to the external). The APE engine 1 comprises an application block 10, an SCTP block 11, a COM Address Manager (CAM) 12 described above and an IP encapsulation & decapsulation block 13. The COM engine 2 comprises an application block 20, an SCTP block 21, an Interface Monitor (IM) 22 as described above an IP encapsulation & decapsulation block 23. Furthermore, the COM engine 2 also comprises a port number detector 24, which serves to judge whether an incoming packet is intended for the APE engine 1 or the COM engine 2 based on the port number of the packet. The port number detector 24 and its function is described later in more detail. The APE engine 1 and the COM engine 2 are connected via an encapsulated connection, i.e., a tunnel, which is denoted by reference numeral 3 in FIG. 1.

As shown in FIG. 1, the Interface Monitor 22 in the COM engine 2 can get the address/interface information and be aware the changes of the interfaces to the external hosts, and then transfer the information to the APE engine (in detail, to the COM Address Manager 12). When a SCTP application is initiated from the APE engine 1, it uses COM's IP address as its address and includes the addresses inside SCTP INIT chunk to let the remote SCTP peer know the multiple addresses of mobile device.

Additionally, for mobility support, the Interface Monitor (IM) 22 on the COM engine should be aware the change of the interfaces of COM. When COM activates or deletes an interface, the Interface Monitor 22 sends an interface change signal to the COM Address Manager (CAM) 12 on the APE engine 1. Consequently, CAM will trigger to send a signal to the SCTP layer, i.e., to the SCTP block 11, and then the SCTP block 11 sends ADD/Delete IP signaling (ASCONF/ASCONF-ACK) to the remote peer and notifies the addresses changes. That is, the SCTP block 11 sends an ASCONF (Address Configuration) chunk including a parameter “Add IP address” or “Delete IP address” to the remote peer (i.e., the external host B in the example of FIG. 1), which responds with an ASCONF-ACK (Address configuration acknowledgement) chunk. The ASCONF chunk and the ASCONF-ACK are sent via the same mechanism as described above, i.e., via the tunnel between the APE engine 1 and the COM engine 2.

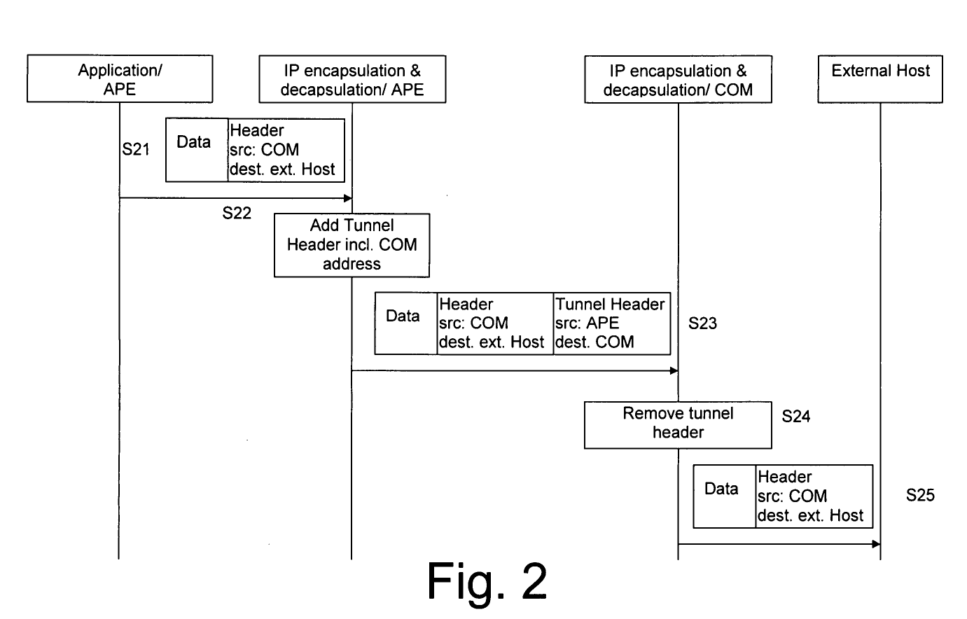

In the following, an example for sending packets from the APE engine to the external host B is shown in FIG. 2. Upon starting this procedure, the application block 10 of the APE engine 1 has generated a packet comprising data and a header. This header comprises as the destination address (indicated by dest in the figure) the address of the external host B, and the source address (indicated by src in the figure) of the packet is one of the addresses of the COM engine 2, which is informed by the COM Address Manager 12.

This packet is forwarded to the IP encapsulation & decapsulation block 12 of the APE engine 1 in step S21. The IP encapsulation & decapsulation block 12 adds a tunnel header to the received packet in step S22. The thus encapsulated packet is forwarded to the COM engine 2 in step S24. In detail, the IP encapsulation & decapsulation block 22 of the COM engine 2 receives the encapsulated packet and removes the tunnel header in step S24, i.e., decapsulates the packet. Then, it can be sent to the original address, i.e., the external host B in step S25.

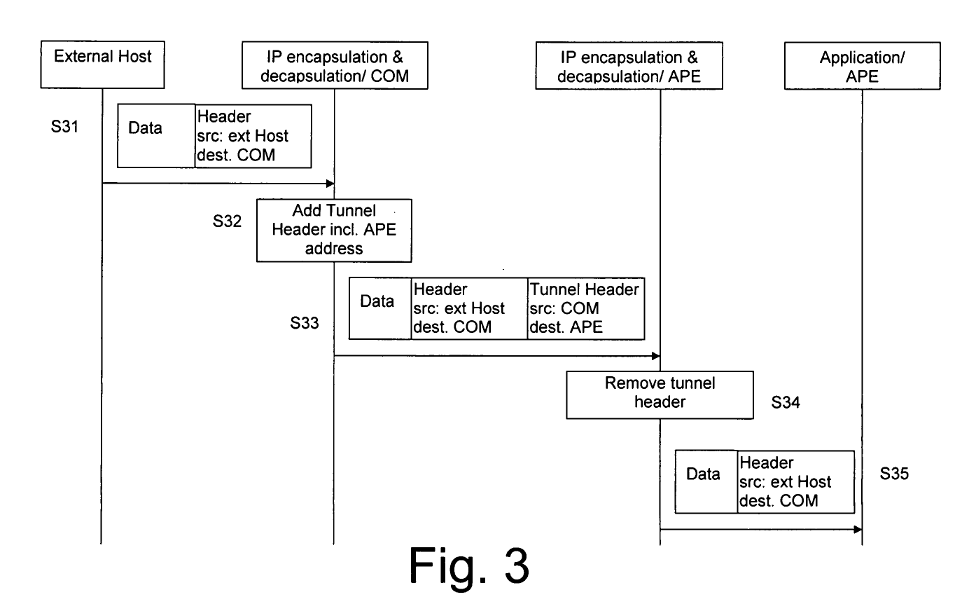

The procedure with respect to receiving a data packet from the external node is carried out basically vice versa and is described in the following by referring to FIG. 3.

In step S31, the external host (such as the external host B shown in FIG. 1) sends a packet to the mobile device A, where it is received at the COM engine 1 and in more detail at the IP encapsulation & decapsulation block 23. The header of this packet comprises as destination address one of the addresses of the COM engine 2. In step S32, the IP encapsulation & decapsulation block 23 of the COM engine 2 encapsulates this packet, namely by adding a tunnel header to the packet, which comprises the local address of the APE engine 1 as the destination address. In step S33, this encapsulated packet is forwarded to the APE engine 1, where it is received by the IP encapsulation & decapsulation block 13. In step S34, the IP encapsulation & decapsulation block 13 decapsulates the received packet, i.e., removes the tunnel header. In step S35, the decapsulated packet is provided to the application block 10 of the APE engine 1. Hence, the packet can be processed by the application block 10 as if it was directly received from the external host. That is, for example the destination address (i.e., one of the addresses of the COM engine 2) can be taken into account.

In the following, the implementation of the embodiment is described in more detail.

Since the SCTP protocol stack is at the Linux kernel, the most of the implementation module are implemented in a loadable kernel module, which attaches to TCP/IP (Transmission Control Protocol/Internet Protocol) stacks networking hook, and a few is implemented as a user space application.

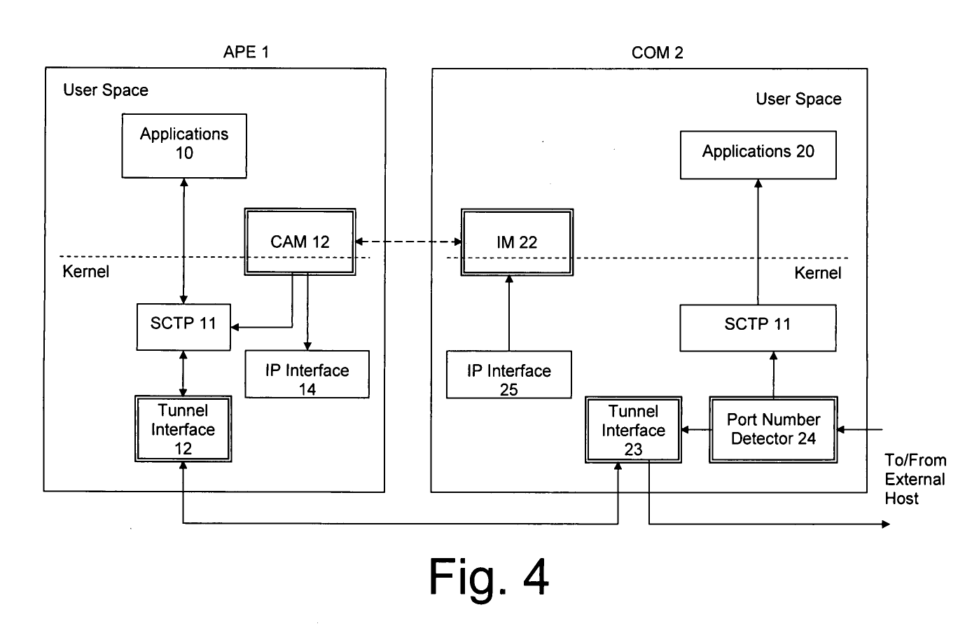

In the following, implementation modules are described by referring to FIG. 4. It is noted that same reference signs as in FIG. 1 denote the same or similar element. Furthermore, the function modules for the tunnelling scheme are indicated by using double lines.

IM (Interface Monitor) 22:

The address information can be obtained via a kernel function and passed to user space daemon, the user space daemon then sends the information to CAM via a TCP connection. The kernel function providing the address information kernel function is a part of IM, and it read the address information from an IP interface 25. The IP interface is a protocol layer below TCP/IP in the kernel, it contains the IP device information and the device driver of the network devices. IP interface keeps an interface queue list to store the data structure of each IP device, the IP address of each device can be read from the data structure.

CAM (COM Address Manager) 12:

The CAM is a user space daemon like SSHD (Secure Shell Daemon) which is always waiting for the messages from the IM 22. When it gets the COM's address, it can configure the addresses as its virtual addresses. The addresses are written into the IP interface 14 as illustrated in FIG. 4. Then, the addresses can be used as the source address of an IP packet to the remote SCTP peer. Moreover, CAM will trigger to send a signal to SCTP layer when COM changes its IP addresses and then SCTP sends ADD/Delete IP signaling (ASCONF/ASCONF-ACK) to the remote peer and notifies the addresses changes.

Tunnel Interface 3:

If using IP tunneling, IP in IP encapsulation/decapsulation for SCTP packet is applied. The tunnel interface must be implemented in both APE and COM, such that the SCTP packet will be encapsulated/decapsulated when SCTP packets are forwarded between APE and COM.

Port Number Detector 24:

If the COM engine 1 receives an incoming SCTP packet (e.g., by using an SCTP capturer), this packet is forwarded to a port number detector 24 shown in FIG. 1. The port number detector 24 is used to judge whether the SCTP packet should be terminated at the COM engine or forwarded to the APE engine. Namely, with respect to the design of dual processor device, server applications are running on the COM engine and client applications are running on the APE engine. Normally, the server applications (running on the COM engine) use well-known port numbers below 1024. Therefore, if the destination port number is between 0-1024, then the SCTP packet will be passed to the application layer, otherwise the SCTP packet goes to the IP encapsulation & decapsulation block 23 described above.

Thus, depending on the judgment of the port number detector 24, the incoming SCTP packet is forwarded to the applications or to an IP address translator 233 described in the following.

In detail, the port number detector 24 works together with the COM (which can also be referred to as MUCK (Multiprocessor Universal Communication Kernel)). Namely, when SCTP packets sent from the remote SCTP peer (e.g., the external host B shown in FIG. 2), the COM has to decide whether the packets should be sent to APE via the tunnel or the packets are intended to be received by a SCTP application (i.e., by the application block 20) on top of COM. For this reason, according to the present embodiment SCTP applications on APE and COM use different port numbers. When a SCTP packet arrives at the COM 2, the port number detector detects the port number of the received SCTP packet. If the port number belongs to APE 1, it will encapsulate the packet in the tunnel and forward the SCTP packet to APE 1, as described above, otherwise, it will deliver it to SCTP protocol stack (i.e., SCTP block 21) on the COM engine 2, which forwards it to the application block 20.

Thus, according to the embodiment described above, a scheme is applied by which an SCTP association between user applications running on an APE engine of a dual processor and an external host can easily be provided.

In particular, the scheme according to the present embodiment is transparent to upper layer applications, and no changes on the SCTP protocol stack are necessary.

The invention is not limited to the embodiment described above, and various modification are possible.

For example, the invention is not limited to the use of SCTP. Any transport layer protocol which has multi-homing support (e.g. SCTP, DCCP, TCP-MH) can utilized this scheme on the dual processor mobile devices

Moreover, the dual-processor mobile phone described in the embodiment above is only an example for a communication device. That is, the invention can be applied to any communication device in which the communication function and other functions are separated between different entities.

In particular, the communication device is not limited to a mobile communication device. The invention can be applied to other devices in which a processing arrangement comprising at least one data processing unit and a communication unit is used. For example, such a processing arrangement may be a chipset or may be a part of a chipset to be used for a communication device or the like.

For example, in this case the communication device may have fixed address, so that it is not necessary to monitor address changes. In this case, it is not necessary to provide the Interface Monitor 22, but the COM Address Manager may have stored the fixed addresses of the communication device in a memory.

Furthermore, the data processing functions may also be performed in more than one entity (e.g., there may be two or more APE processors). In this way, each APE engine (data processing unit) may have its own address. That is, different tunnels may be established between the COM engine the plurality of APE engines. In this way, the COM engine should record the status of each SCTP association on multiple APEs and then assign different port numbers to the associations.

Further, in the embodiment described above, Linux was described as an example for an operating system for the APE and COM engines. However, any suitable operating system can be used instead.

Moreover, the functions described above can be realized by software, but can also be suitable hardware.

Furthermore, according to the embodiment described above, IP in IP tunnelling was described. However, for the connection between the COM and the APE, any suitable protocol can be used, for example PPP (Point-to-Point Protocol) or the like, and also for the connection to the external host other suitable protocols than IP can be used.

In addition, according to the embodiment described above, a distinction between packets intended for APE applications and packets intended COM applications is carried out based on different port numbers of the packet. However, the invention is not limited thereon. For example, one or more addresses of the COM engine 2 could be specifically reserved for this purpose.

1. A processing arrangement, comprising:
at least one data processing unit for performing data processing; and
a communication unit, connected to the data processing unit, for providing a connection to an external wherein
a packet transport control is used for the connection to the external, in which a plurality of addresses may be assigned to the communication unit, and
wherein the communication unit and the data processing unit comprise delivering means for delivering packets, which are to be delivered between the data processing unit and the external, via an encapsulated connection between the data processing unit and communication unit.

2. A processing arrangement according to claim 1, wherein the data processing unit comprises means for generating packets by using addresses of the communication unit as a source address, wherein the delivering means of the data processing unit comprises means for encapsulating said packets by using the address of the communication unit as address of the encapsulated packet.

3. A processing arrangement according to claim 2, wherein the delivering means of the communication unit comprises means for decapsulating the encapsulated packets received from the data processing unit and means for sending the decapsulated packet to the external.

4. A processing arrangement according to claim 1, wherein the delivering means of the communication unit comprises means for encapsulating packets received from the external by using the local address of the data processing unit as the address of the encapsulated packet, and the communication unit comprises means for sending the encapsulated packets to the data processing unit.

5. A processing arrangement according to claim 4, wherein the delivering means of the data processing unit comprises means for decapsulating said received packets.

6. A processing arrangement according to claim 1, wherein the communication unit comprises an interface monitoring means for monitoring address changes of the communication unit and for forwarding address information to the data processing unit.

7. A processing arrangement according to claim 1, wherein the data processing unit comprises an address managing means for assigning addresses of the communication unit to the packets, which are to be sent between the data processing unit and the external.

8. A processing arrangement according to claim 6, wherein the data processing unit comprises an address managing means for assigning addresses of the communication unit to the packets, which are to be sent between the data processing unit and the external, wherein the address managing means is configured to receive the address information sent from the interface monitoring means of the communication unit.

9. A processing arrangement according to claim 1, wherein the communication unit comprises a packet type distinguishing means for detecting the type of a packet and for forwarding the packet to an application part of the communication unit depending on the type of the packet.

10. A processing arrangement according to claim 9, wherein the packet type distinguishing means comprises means for detecting the type of a packet based on a port number of the packet.

11. A processing arrangement according to claim 1, wherein the transport protocol is Stream Control Transport Protocol (SCTP), Datagram Congestion Control Protocol (DCCP) or Transport Control Protocol-Multi-Homing (TCP-MH).

12. A processing arrangement according to claim 1, comprising a first and a second processor, wherein the first processor comprises the data processing unit and the second processor comprises the communication unit.

13. A communication device comprising: a processing arrangement, comprising:
at least one data processing unit for performing data processing; and
a communication unit, connected to the data processing unit, for providing an external, wherein
a packet transport control is used for the connection to the external, in which a plurality of addresses may be assigned to the communication unit, and
wherein the communication unit and the data processing unit comprise delivering means for delivering packets, which are to be delivered between the data processing unit and the external, via an encapsulated connection between the data processing unit and communication unit.

14. A method for performing communication of a processing arrangement wherein the processing arrangement comprises at least one data processing unit, and a communication unit connected to the data processing unit and configured to provide a connection to an external node, wherein
a packet transport control is used for the connection between the communication unit and the external node, in which packet transport protocol a plurality of addresses may be assigned to the communication unit, the method comprising the step of:
delivering packets, which are to be delivered between the data processing unit and the external node, via an encapsulated connection between the data processing unit and the communication unit.

15. A method according to claim 14, further comprising the steps of:
generating packets by using addresses of the communication unit as a source address in the data processing unit, and
encapsulating the packets by using an address of the communication unit as an address of the encapsulated packet, wherein
in the delivering step, the encapsulated packets are sent to the communication unit.

16. A method according to claim 15, further comprising the step of:
decapsulating the encapsulated packets received from the data processing unit in the communication unit; and
sending the decapsulated packet to the external node.

17. A method according to claim 14, further comprising the step of
encapsulating packets received from the external node in the communication unit by using a local address of the data processing unit as an address of the encapsulated packet, wherein
in the delivering step, the encapsulated packets are sent to the data processing unit.

18. A method according to claim 17, further comprising the step of:
decapsulating the received packets in the data processing unit.

19. A method according to claim 14, further comprising the steps of:
monitoring address changes of the communication unit; and
forwarding address information to the data processing unit.

20. A method according to claim 14, further comprising the step of:
assigning addresses of the communication unit to the packets, which are to be sent between the data processing unit and the external node, in the data processing unit.

21. A method according to claim 14, further comprising the step of:
assigning addresses of the communication unit to the packets, which are to be sent between the data processing unit and the external node, in the communication unit,
wherein in the assigning step, address information sent in forwarding address information are used.

22. A method according to claim 14, further comprising the steps of:
detecting a type of a packet and
forwarding the packet to an application part of the communication unit depending on the type of the packet.

23. A method according to claim 22, wherein the packet type detecting step detects the type of a packet by detecting a port number of the packet.

24. A method according to claim 14, wherein the transport protocol is Stream Control Transport Protocol (SCTP), Datagram Congestion Control Protocol (DCCP) or Transport Control Protocol-Multi-Homing (TCP-MH).

25. A computer program embedded on computer-readable medium, comprising software code portions for performing the steps of claim 14 when the program is run on the computer.

26. A communication unit, wherein a packet transport control is used for the connection to the external, in which a plurality of addresses may be assigned to the communication unit, wherein
the communication unit comprises delivering means for delivering packets, which are to be delivered between a data processing unit and the external, via an encapsulated connection between the data processing unit and communication unit.

27. A communication unit according to claim 26, wherein the delivering means of the communication unit comprises means for decapsulating encapsulated packets received from the data processing unit and means for sending the decapsulated packet to the external.

28. A communication unit according to claim 26, wherein the delivering means comprises means for encapsulating packets received from the external by using the local address of the data processing unit as the address of the encapsulated packet, and the communication unit comprises means for sending the encapsulated packets to the data processing unit.

29. A communication unit according to claim 26, further comprising an interface monitoring means for monitoring address changes of the communication unit and for forwarding address information to the data processing unit.

30. A communication unit according to claim 26, further comprising a packet type distinguishing means for detecting a type of a packet and for forwarding the packet to an application part of the communication unit depending on the type of the packet.

31. A communication unit according to claim 30, wherein the packet type distinguishing means is configured to detect the type of a packet based on the port number of the packet.

32. A data processing unit, wherein
the data processing unit is configured to perform data processing and a packet transport control is used for the connection to the external, in which a plurality of addresses may be assigned to a communication unit connected to the data processing unit, and
the data processing unit comprises delivering means for delivering packets, which are to be delivered between the data processing unit and the external, via an encapsulated connection between the data processing unit and communication unit.

33. A data processing unit according to claim 32, further comprising means for generating packets by using addresses of the communication unit as a source address, wherein the delivering means comprises means for encapsulating said packets by using the address of the communication unit as an address of the encapsulated packet.

34. A data processing unit according to claim 32, wherein the delivering means comprises means for decapsulating packets received from the communication unit via the encapsulated connection.

35. A data processing unit according to claim 32, further comprising an address managing means for assigning addresses of the communication unit to the packets, which are to be sent between the data processing unit and the external.

36. A data processing unit according to claim 35, wherein the address managing means comprises means for receiving address information sent from the communication unit.

37. A processing arrangement, comprising:
at least one data processing unit; and
a communication unit connected to the data processing unit, wherein
the at least one data processing unit is configured to perform data processing and the communication unit is configured to provide a connection to the external, and
wherein a packet transport control is used for the connection to the external, in which a plurality of addresses may be assigned to the communication unit, and
the communication unit and the data processing unit comprise delivering means configured to deliver packets, which are to be delivered between the data processing unit and the external, via an encapsulated connection between the data processing unit and communication unit.

38. A processing arrangement according to claim 37, wherein the data processing unit comprises an address generating means configured to generate packets by using addresses of the communication unit as a source address, wherein the delivering means of the data processing unit is configured to encapsulate said packets by using the address of the communication unit as address of the encapsulated packet.

39. A processing arrangement according to claim 38, wherein the delivering means of the communication unit is configured to decapsulate the encapsulated packets received from the data processing unit and to send the decapsulated packet to the external.

40. A processing arrangement according to claim 37, wherein the delivering means of the communication unit is configured to encapsulate packets received from the external by using a local address of the data processing unit as an address of the encapsulated packet, and the communication unit is configured to send the encapsulated packets to the data processing unit.

41. A communication unit, wherein a packet transport control is used for the connection to the external, in which a plurality of addresses may be assigned to the communication unit, wherein
the communication unit comprises delivering means configured to deliver packets, which are to be delivered between a data processing unit and the external, via an encapsulated connection between the data processing unit and communication unit.

42. A communication unit according to claim 41, wherein the delivering means of the communication unit is configured to decapsulate encapsulated packets received from the data processing unit and to send the decapsulated packet to the external.

43. A communication unit according to claim 42, wherein the delivering means is configured to encapsulate packets received from the external by using the local address of the data processing unit as the address of the encapsulated packet, and the communication unit is configured to send the encapsulated packets to the data processing unit.

44. A data processing unit, wherein
the data processing unit is configured to perform data processing and a packet transport control is used for the connection to the external, in which a plurality of addresses may be assigned to a communication unit connected to the data processing unit, and
the data processing unit comprises delivering means configured to deliver packets, which are to be delivered between the data processing unit and the external, via an encapsulated connection between the data processing unit and communication unit.

45. A data processing unit according to claim 44, further comprising means configured to generate packets by using addresses of the communication unit as a source address, wherein the delivering means is configured to encapsulate said packets by using the address of the communication unit as address of the encapsulated packet.

46. A data processing unit according to claim 44, wherein the delivering means is configured to decapsulate packets received from the communication unit via the encapsulated connection.
